(19) United States
(12) Patent Application Publication
(10) Pub. No.: US 2026/0187213 A1
(43) Pub. Date: Jul. 2, 2026

(54) ULTRASONIC ANTISPOOF USING MULTIPLE ACOUSTIC CHANNELS

(71) Applicant: GOOGLE LLC, Mountain View, CA (US)

(72) Inventors: Octavio PONCE MADRIGAL, Mountain View, CA (US); Patrick Muller AMIHOOD, Mountain View, CA (US)

(21) Appl. No.: 19/129,139

(22) PCT Filed: Feb. 24, 2023
(86) PCT No.: PCT/US2023/013835

§ 371 Date: May 12, 2025

(51) Int. Cl. G06F 21/32; G01S 15/58; G01S 15/89; G06V 40/16; G06V 40/40; H04M 1/72403

(52) U.S. Cl. CPC G06F 21/32; G01S 15/582; G01S 15/89; G06V 40/172; G06V 40/40; H04M 1/72403

(57) ABSTRACT

The subject matter in this disclosure relates to technology in which a speaker outputs an acoustic waveform; records, by a first microphone, a first reflection of the acoustic waveform that was output by the speaker; records, by a second microphone, a second reflection of the acoustic waveform that was output by the speaker; determines a computed representation of an environment surrounding the computing device, based on the first reflection of the acoustic waveform and the second reflection of the acoustic waveform; provides the computed representation of the environment to a computational model that is configured to determine whether the computed representation of the environment surrounding the computing device indicates presence of a human face; and receives from the computational model, an indication that the environment surrounding the computing device includes a human face.

### TECHNICAL FIELD

This document relates to technologies for identifying a human face based on analysis of acoustic waveforms.

### BACKGROUND

Some computing devices are configured to authenticate a user of the computing device by analyzing an image of the user's face. For example, a mobile device receiving an unlock request can perform a face authentication process to determine whether a user holding the mobile device is an authenticated user of the device. The mobile device may capture a picture with its front-facing camera, and analyze the picture to determine if there is a face in the image that matches a face of an authenticated user (e.g., an image of a face that was previously-captured during a setup operation for the face authentication process).

A concern with face authentication processes is that a malicious user can present an image of an authorized individual to “spoof” the face authentication process. For example, a malicious user can hold up a printed image or computer display that shows the authorized face, potentially providing the malicious user with access to protected information and/or services.

### SUMMARY

This document describes technologies for identifying a human face based on analysis of acoustic waveforms. A user computing device can generate an acoustic waveform with a speaker, and microphones of the user computing device can record acoustic reflections that are formed as the acoustic waveform bounces off objects in the environment surrounding the user computing device.

The user computing device can analyze the recorded reflections of the acoustic waveform and determine therefrom whether the environment surrounding the user computing device includes an object with shape and acoustic reflective properties that match those of a human face. The acoustic analysis process may assign probabilities that an object in the environment satisfies various object classifications, including for example: a human face, an object with a flat surface (e.g., a piece of paper or display device), and a mask that mimics the shape of a human face.

The user computing device can use the determined probabilities (e.g., 96% human face, 3% mask, 1% flat surface) as at least part of a determination regarding whether to authenticate a user to access certain computing resources. The determination whether to authenticate the user may also be based on the results of an image-sensor-based face authentication process. For example, an image-sensor-based face authentication process may determine an amount of similarity between facial features of: (i) a face present in an image captured by a forward-facing camera of the user computing device, and (ii) a stored image of an authenticated face. The computing device can use both the acoustic-based analysis and the image-sensor-based analysis in its authentication process.

Sound waves generally propagate in all directions through air, from a location of an electroacoustic speaker, similar to how waves in water will “bend” around a corner of an object located in the water. As such, a forward-facing speaker located on a front side of a user computing device will project sound waves not only toward the face of a user that is holding the device, but also in the opposite direction—behind the phone. If the user's face and an object behind the user device are a same distance from the user device, then acoustic reflections that bounce off the user's face and acoustic reflections that bounce off the behind-device object can arrive at a microphone of the user computing device at a same time.

The energies of simultaneously-arriving sound waves combine, such that the sound recorded by the microphone represents a combination of sound waves reflecting from the user's face and sound waves reflecting from an object behind the user computing device. A sound recording of the simultaneously-arriving sound waves at least partially obscures sonic characteristics specific to acoustic reflections from the user's face. In other words, acoustic analysis of an object is hampered by the presence of another object located the same distance from a speaker/microphone pair.

In some implementations, an object located behind a device that includes the speaker/microphone pair (hereinafter a “behind-device object”) may affect a microphone recording of an acoustic wave more than if the same object were located at the same distance but to the peripheral sides of the device. In other implementations, a device that includes a speaker/microphone pair may generate acoustic radial symmetry. The terminology “behind-device object” is meant to include an object that is behind a user device, from the perspective of a user in front of the device, while the device is tilted, even though such an object may not be directly “behind” the device from the perspective of the tilted device.

This disclosure presents technologies that can mitigate the effect of a behind-device object, during an acoustic sounding process that is used to determine whether a human face is present in front of a user device. Some such mitigation technologies include: (i) precording acoustic reflections with a second microphone located on an opposite side of the user device, (ii) limiting analysis of acoustic reflections to those received within a limited time window from production of the acoustic waveform, (iii) shielding the speaker and/or microphone(s) to focus sensitivity and effectiveness of the transducers to sounds waves in front of the user computing device, (iv) analyzing both the acoustic reflections and high-pass-filtered versions of the acoustic reflections together, and (v) training a computational model to recognize different types of acoustic signatures, including the presence of a human face in front of the user device (e.g., in distinction to a non-face “spoof” object, such as an object with a flat surface or a mask worn on a human face) while a behind-device object is concurrently located behind the user device.

Recording acoustic reflections with a second microphone that is located on an opposite side of the user device can provide diversity that enables the computing device to distinguish between reflections that bounce off a front-side positioned object and reflections that bounce off a rear-side positioned object. For example, sound recorded by a forward-facing microphone may include a higher proportion of acoustic reflections that bounced off a front-side positioned object than acoustic reflections that bounced off a rear-side positioned object. Conversely, sound recorded by a rear-facing microphone may include a higher proportion of acoustic reflections that bounced off a rear-side positioned object than acoustic reflections that bounced off a front-side positioned object (at least in comparison to sound recorded by the forward-facing microphone). Computational processes that analyze recordings from both microphones can infer which portion of the recorded reflections represent the front-side positioned object, for example, using one or more heuristics or trained machine learning models.

Limiting analysis of acoustic reflections to those received within a limited amount of time from production of the acoustic waveform can ensure that the recorded sound data being analyzed represents only objects within a certain distance of the user computing device. For example, the user device may be configured to analyze the acoustic reflections of only those objects within 60 centimeters of the user device. This range limitation can be established based on a threshold amount of time that it takes sound to travel 120 centimeters—from the user device to an object 60 centimeters away, and back to the user device. In some examples, the range limitation is based on an amount of time it takes sound to travel 200 centimeters. The user computing device may stop recording once the threshold amount of time is reached, or the user computing device may continue recording but only analyze sound recorded before the threshold amount of time was reached.

Shielding the speaker and/or microphone(s) can focus the sensitivity and effectiveness of the transducers to sounds waves located in front of each respective transducer. For example, a front-facing microphone can be placed in a recess that is adapted to diminish the strength of acoustic reflections that are propagating toward the front-facing microphone from directions not within a configured angular section (e.g., 20 degrees) of the front surface of the user device. Similarly, a rear-facing microphone can be placed in a recess that is adapted to diminish the strength of acoustic reflections that are propagating toward the rear-facing microphone from directions not within a configured angular range (e.g., 30 degrees) of the rear surface of the user device. Microphone types that are adapted to record directional sounds may be selected for use, rather than selecting omni-directional microphone types. The user device may shield side returns to ensure a side lobe ratio of 25 dB or smaller. In some implementations, the system described in this disclosure uses a front-facing microphone, without use of a rear-facing microphone (or possibly without use of any other microphone), for example, in implementations in which the microphone type and installation provide particular sensitivity to front-facing targets.

Analyzing both the acoustic reflections and high-pass-filtered versions of the acoustic reflections provide an ability to distinguish between static and dynamic targets. A system trained to analyze both types of targets can help the user device distinguish between a front-side object and a rear-side object in different conditions (e.g., when objects are moving and not moving). Applying a high-pass filter to acoustic reflection data can remove from the acoustic reflection data reflections from static objects, leaving acoustic reflection data from moving objects. An example, in which acoustic data specific to moving objects can be helpful is when a user is moving their face during a face authentication process. This additional set of two acoustic channels (one additional channel generated by high-pass filtering the forward-facing microphone data and one additional channel generated by high-pass filtering the rear-facing microphone data) facilitates heuristic and/or trained computational model analysis of acoustic data.

Training a computational model to recognize different types of acoustic signatures, including the presence of a human face in front of the user device while a behind-device object is concurrently located behind the user device, ensures that the user device can characterize recorded audio as indicating presence of a human face, even when one or more objects may be located a same distance to the user device as the face.

Particular implementations of the technology disclosed herein can realize one or more of the advantages. Using speakers and microphones can provide a mechanism to analyze a human face that is orthogonal to image-sensor-based analysis. A user device may already include a speaker and at least one microphone suitable for use in acoustic-based face analysis, limiting the need for additional sensors (e.g., infrared sensors) that may be dedicated to face analysis. This reduction in need for additional sensors can limit the bill of goods for the user device. And to the extent a design of a user device is modified to include an additional rear-side microphone at a location suitable to service acoustic-based face analysis, the additional rear-side microphone may be less expensive than another type of non-acoustic sensor. Such an additional microphone may also be used by other additional acoustic processes (e.g., noise cancellation processes).

Implementing an acoustic-based face analysis system can thwart malicious users from “spoofing” a face authentication system with printed images of an authorized face and/or a mask of an authorized face. Acoustic-based analysis of an object may be able to reveal acoustic characteristics of the object that infrared, image, and/or proximity sensors are unable to detect, such as composition of the object (e.g., rigidity of material forming the object).

Performing acoustic-based face analysis can provide orthogonal analysis of a user's face with modest computational burden, limiting energy usage and providing a quick mechanism to analyze a user's face. The processes described below for processing audio recordings and analyzing such recordings may be performed efficiently and quickly by a processing system of the user device.

The details of one or more implementations are set forth in the accompanying drawings and the description below. Other features, objects, and advantages will be apparent from the description and drawings, and from the claims.

### DESCRIPTION OF DRAWINGS

FIG. 1 illustrates a mobile computing device performing acoustic-based analysis of a human face.

FIG. 2 shows a mobile computing device performing acoustic-based analysis of a user face, while a behind-device object is present.

FIG. 3 shows an example process for training a face-detection system.

FIG. 4 illustrates how a computing system determines multiple Doppler representations of a received sound wave from a recording of the sound wave.

FIG. 5 shows various types of acoustic data generated from recorded reflections of an acoustic waveform.

FIG. 6 illustrates a portion of a convolutional process.

FIG. 7 illustrates additional aspects of the convolutional process.

FIG. 8 illustrates how the computing system generates parameters for a computational model.

FIG. 9 illustrates a runtime face-detection process.

FIG. 10 is a conceptual diagram of a system that may be used to implement the systems and methods described in this document.

FIG. 11 is a block diagram of computing devices that may be used to implement the systems and methods described in this document, as either a client or as a server or plurality of servers.

Like reference symbols in the various drawings indicate like elements.

### DETAILED DESCRIPTION

This disclosure describes technologies for identifying a human face based on analysis of acoustic waveforms.

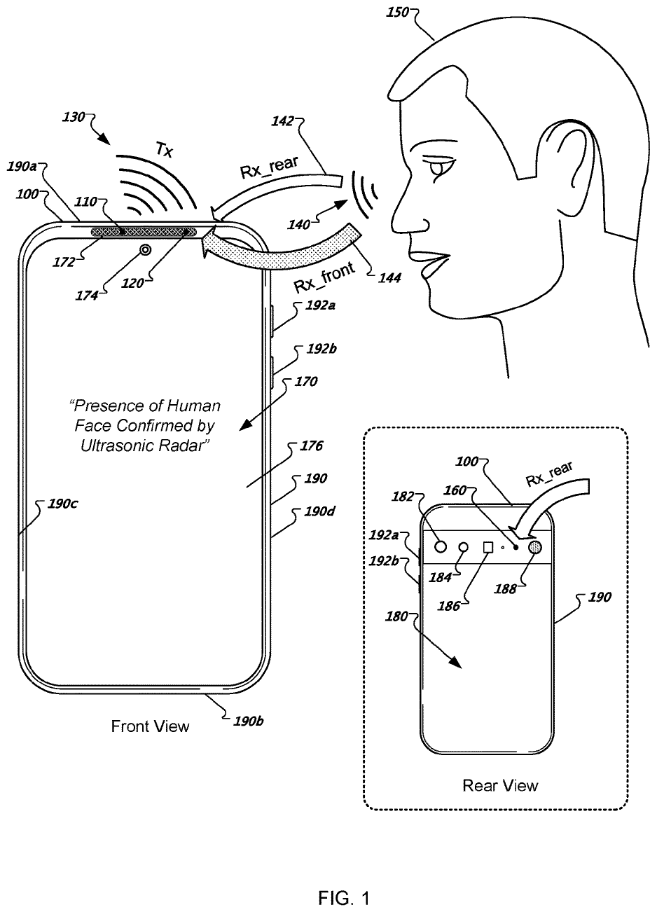

FIG. 1 illustrates a mobile computing device performing acoustic-based analysis of a user face. In this illustration, mobile computing device 100 includes a speaker 110 that outputs an acoustic waveform 130 (designated as “Tx” in the figure), which bounces off a human face 150 to generate a reflected sound wave 140. This reflected sound wave propagates back toward device 100, and is received by a front-facing microphone 120 and a rear-facing microphone 160. The acoustic waveform recorded by each of the microphones 120 and 160 differs due to placement the microphones 120 and 160, such that: (1) front-facing microphone 120 records a first version 142 of the reflected sound wave 140 (designated “Rx_front” in FIG. 1), and (2) rear-facing microphone 160 records a second version 144 of the reflected sound wave 140 (designated Rx_rear in FIG. 1).

Mobile device 100 (or another device in communication therewith) analyzes the Rx_front and Rx_rear recordings, and determines therefrom whether a human face is located in front of the mobile device 100. FIG. 1 includes a touchscreen 176 that displays the phrase “Presence of Human Face Confirmed by Ultrasonic Radar” to indicate that the face 150 was properly authenticated, although various implementations may not indicate authentication by displaying text in this manner.

Mobile device 100 includes a front side 170 and a rear side 180 that are separated by a periphery 190. The front side 170 includes—in addition to the front-facing speaker 110 and front-facing microphone 120—a display 176 and a front-facing camera 174. The front-facing speaker 110 and the front-facing microphone 120 may be located behind a common portion of mesh (e.g., a speaker grille). The front-facing speaker 110 and the front-facing microphone may share an aperture/speaker channel.

The rear side 180 of the mobile device 100 includes—in addition to the rear-facing microphone 160—a rear-facing standard-view camera 182, a rear-facing wide-angle camera 184, a rear-facing telephoto camera 186 that includes a mechanically-adjustable lens, and a rear-facing light-emitting diode 188 to provide flash functionality.

The periphery 190 of the mobile device 110 includes a top side 190a, a bottom side 190b, a left side 190c, and a rear side 190d. The right side 190d of the periphery 190 includes buttons 192a-b. The bottom side 190b may include an additional one or more speakers and a charging port (not shown in the figures).

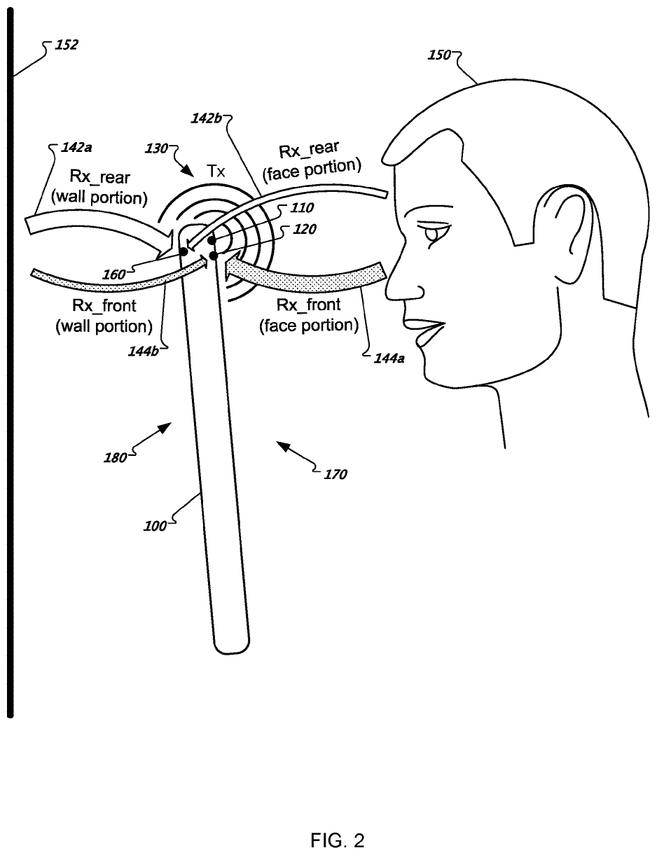

FIG. 2 shows the mobile computing device 100 performing acoustic-based analysis of the user face 150, while a behind-device object 152 is located behind the computing device. In this illustration, the behind-device object 152 is illustrated as a flat wall, but the behind-device object 152 may be a table surface (e.g., when the user is sitting at a table), a computer monitor (e.g., when the user is at their computer), bedding (e.g., when the user is laying in bed), or another type of object (e. g,. a vase sitting out on a surface).

In examples in which a behind-device object 152 is present, the transmitted acoustic soundwave 130 reflects off both the human face 150 and the behind-device object 152, such that recordings produced by the forward-facing microphone 120 and the rear-facing microphone 160 each include a component representing a reflection off the human face 150 and a component representing a reflection off the behind-device object 152. For example, the Rx_front recording includes a face portion 144a and a wall portion 144b, and the Rx_rear recording includes a wall portion 142a and a face portion 142b.

As illustrated by the different sizes of the arrows in FIG. 2, a greater proportion of an intensity of the recording by the front-facing microphone 120 is formed by reflections off the human face 150 than by reflections off the behind-device object 152 (e.g., due to the front-facing position of the microphone 120 and shielding). Conversely, a greater proportion of an intensity of the recording by the rear-facing microphone 160 is formed by reflections off the behind-device object 152 than by reflections off the human face 150. These two recordings can be analyzed and compared by the computing device 100 to infer acoustic characteristics of an object located in front of the computing device 100.

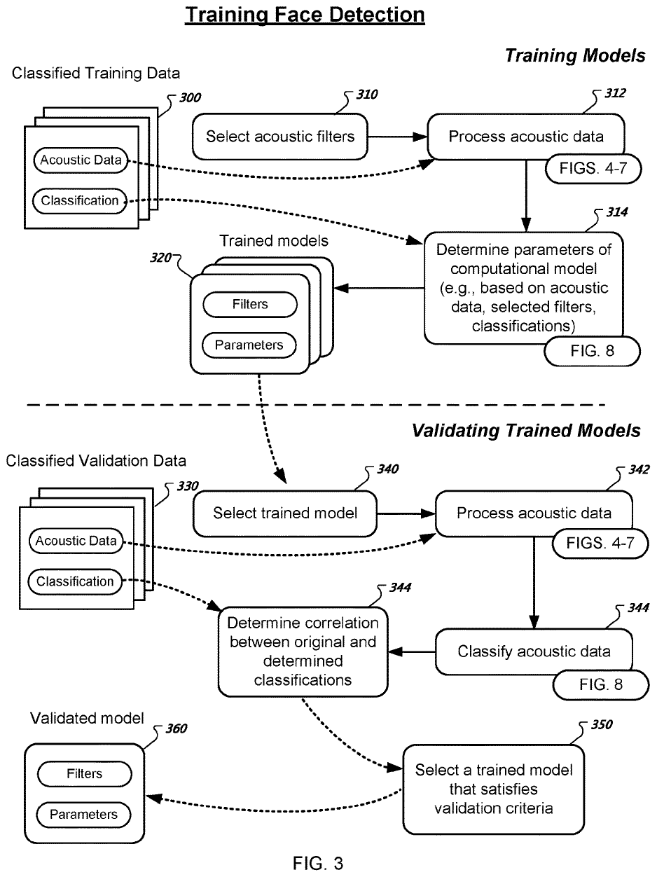

FIG. 3 shows an example process for training a face-detection system. A top portion of FIG. 3 shows a process that generates a set of trained models 320 based on an input set of classified training data 300. A bottom portion of FIG. 3 shows how the trained models 320 are input into a validation process that applies classified validation data 330 to the trained models 320, to select one or more validated models 360 that satisfy validation criteria.

The classified training data 300 can include a collection of sets of acoustic data and a classification therefore. The acoustic data in each set may represent at least two acoustic recordings generated by two microphones of a user device (e.g., a front-facing and rear-facing microphone) for a corresponding environmental condition. In some implementations, the acoustic data can include further “channels” of input data, including high-pass-filtered versions of the two acoustic recordings—as discussed in additional detail further below.

The classification in each set may include a label that identifies/classifies an environment in which the user device was located when the acoustic recording was generated. Example classifications include human face, human face with behind-device object, flat object, and mask of human face.

The classified training data can include thousands of instances of such data, for example, thousands of sets of acoustic data classified as a human face, thousands of sets of acoustic data classified as a human face with a behind-device object, and so forth.

At box 310, the training process involves selecting a set of acoustic filters 310. The filters 310 may be kernel filters used in a convolution process, and may be selected randomly or according to algorithmic criteria by the training system.

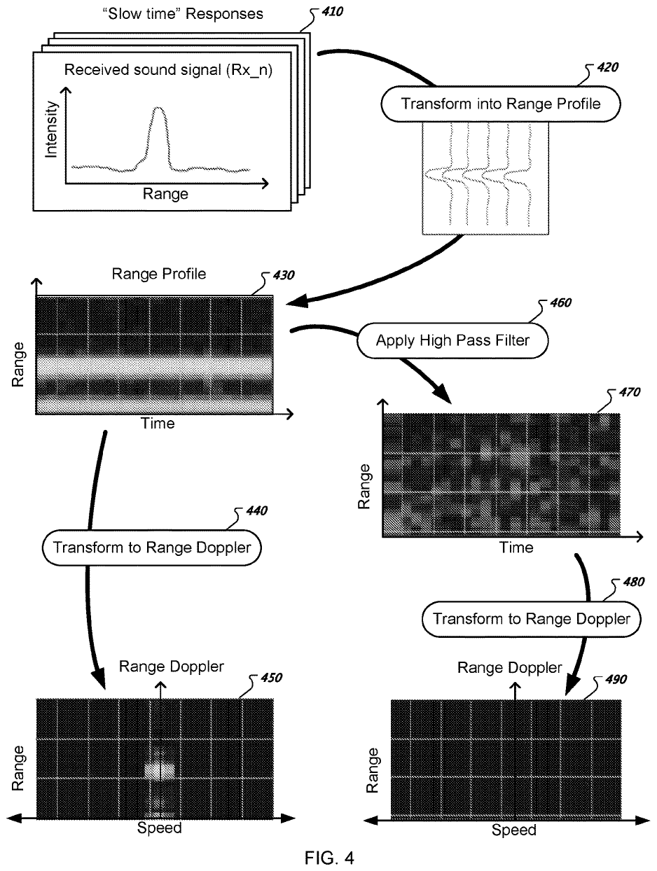

At box 312, the acoustic data is processed, using the selected acoustic filters and at least a subset of the classified training data 300. The processing generates a set of processed acoustic data suitable for determining parameters of a computational model. FIGS. 4-7 illustrate how the system processes the acoustic data.

FIG. 4 illustrates how a computing system determines multiple Doppler representations of a received sound wave from a recording of the sound wave. A computing device initially outputs a waveform with a front-facing speaker. The waveform may include a series of pulses (e.g., 6 kHz or more bandwidth) output at 120 Hz, with one pulse every 8.3 milliseconds for a period of approximately 200 milliseconds. Each pulse may include a pseudo-random code, represent a single tone, or provide a frequency modulated continuous waveform.

Each microphone thereafter records the reflections generated by the pulses. The recording may be continuous, or may include a series of recordings—one for each pulse. The “slow time” responses 410 shown in FIG. 4 represent such a series of recordings. Each recording indicates an intensity of received sound over a period of time, with time denoted as “Range” to indicate that reflections received quickly represent a near-range object while reflections received more slowly represent a far-range object.

At box 420, a computing system transforms the series of “slow time” responses 410 to a range profile 430. The transformation can include stacking the set of slow-time responses 410 vertically to generate a two-dimensional representation of the recorded sound with: (i) a range to an object indicated by the vertical axis, (ii) an intensity of a sound reflection indicated by value at each location in the range profile, and (iii) how the reflection changes over time represented by the horizontal axis. The computing system that performs the transformation can include a device that recorded the received reflections and/or a server system that processes such data.

At box 440, the computing system transforms the range profile 430 into a Doppler representation 450 of the acoustic data, referenced in FIG. 4 as a “range Doppler” of the acoustic data. The transformation may include performing a fast-Fourier transformation (FFT) of the range profile. The Doppler representation 450 of the acoustic data represents the received sound with: (i) range to object indicated by the vertical axis, (ii) intensity of sound reflection indicated by value at each location, and (iii) a speed of movement of the object toward or away from the recording device, as indicated by a location of the object/reflection with respect to the left or right of a center vertical axis. A location of the object/reflection that is located on the center vertical axis indicates an object that is not moving toward or away from the user device.

At box 460, the computing system applies a high-pass filter to the range profile 430 to generate a high-pass-filtered range profile 470 of the acoustic data. Performing this filtering operation removes from the range profile 430 reflections indicative of static objects, leaving representations of any one or more objects that were moving during the acoustic sounding process. This filtering also removes the effect of nearfield interference, such as vibrations that travel directly from a speaker to a microphone through a housing of the mobile device (or through the air), without bouncing off an external object.

At box 480, the high-pass-filtered range profile 470 is transformed into a high-pass-filtered Doppler representation 490 of the acoustic data, for example by performing an FFT on the high-pass-filtered range profile 470.

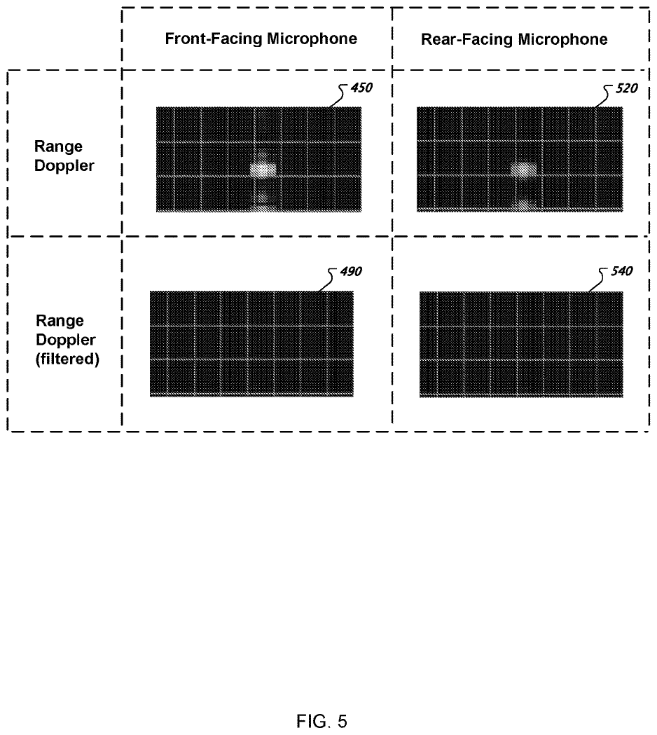

FIG. 5 shows various types of acoustic data generated from recorded reflections of an acoustic waveform. FIG. 4 was described above with respect to a front-facing microphone, generating the Doppler representation 450 of the acoustic data and the high-pass-filtered Doppler representation 490 of the acoustic data. The process of FIG. 4 can also be performed using the recording produced by the rear-facing microphone, similarly generating the Doppler representation 520 of the acoustic data and the high-pass-filtered Doppler representation 540 of the acoustic data.

The above-described range profiles and range dopplers represent complex data that indicate magnitude and phase, even though the illustrations in FIGS. 4-6 may not indicate imaginary data (e.g., the illustrations indicate magnitude but not phase).

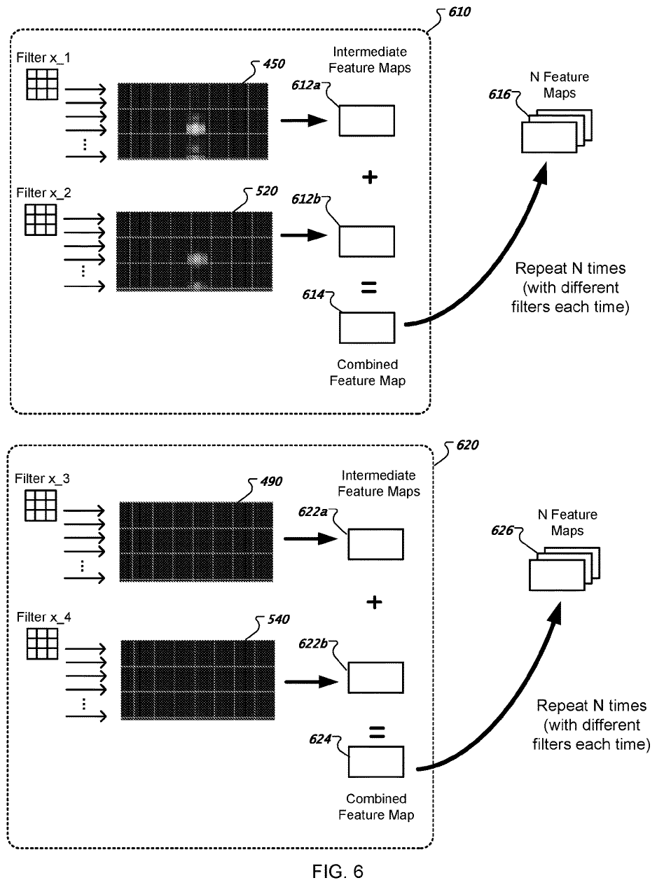

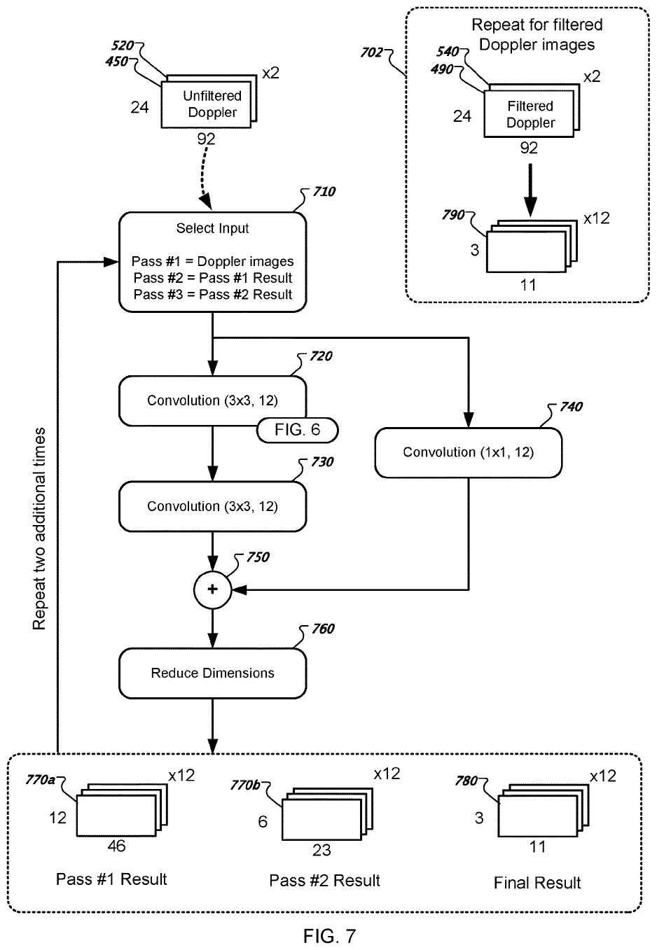

FIG. 6 illustrates a portion of a convolutional process that the computing system performs (with FIG. 7 illustrating the entire convolutional process), to extract relevant features from the acoustic data shown in FIG. 5. A convolution is an application of a filter to an input that results in an activation. Repeated application of same filter to different locations of the input results in a map of activations, called a feature map. The feature map can indicate the locations and strengths of a detected feature of an input, for example, a range Doppler representation of an acoustic recording. The convolutional processes shown in FIG. 6 applies filters x_1 through x_4 to the acoustic data shown in FIG. 5 by way of convolutional processes 610 and 620.

A first convolutional process 610 applies filter x_1 to various locations of acoustic data 450 (e.g., a range Doppler generated from a front-facing microphone), as represented by the horizontal arrows that show how the filter is applied to multiple locations in each of multiple rows. A result of applying filter x_1 to acoustic data 450 is an intermediate feature map 612a. The first convolutional process 610 similarly applies filter x_2 to acoustic data 520 (e.g., a range Doppler generated from a rear-facing microphone), to generate intermediate feature map 612b. The first convolutional process 610 combines the intermediate feature maps 612a-b (e.g., by adding the values together) to generate a combined feature map 614.

The content of filters x_1 and x_2 may be different from each other, and selected by a process that provides various different types of filters for use in identifying appropriate filters for a process of training a computational model (as with the other filters used in the convolutional training processes). The first convolutional process 610 may be repeated N times (e.g., 12 times) with different filters x_1 and x_2 each time, to generate a first collection of N feature maps 616 (e.g., 12 feature maps).

A second convolutional process 620 applies filter x_3 to various locations of acoustic data 490 (e.g., a high-pass-filtered range Doppler generated from the front-facing microphone). A result of applying filter x_3 to acoustic data 490 is an intermediate feature map 622a. The second convolutional process 620 similarly applies filter x_4 to acoustic data 540 (e.g., a high-pass-filtered range Doppler generated from the rear-facing microphone), to generate intermediate feature map 614b. The second convolutional process 620 combines the intermediate feature maps 622a-b (e.g., by adding the values together) to generate a combined feature map 624. The second convolutional process 620 may be repeated N times (e.g., 12 times) with different filters x_3 and x_4 each time, to generate a second collection of N feature maps 624 (e.g., 12 feature maps)

In some implementations, each of the range Dopplers illustrated in FIG. 5 have a size of 24×92 pixels. The filters x_1 through x_4 may each have a size of 3×3. The various feature maps may each have a size of 24×92 pixels, such that the feature maps match a size of the range Dopplers that are input into the convolutional process.

FIG. 7 illustrates additional aspects of the convolutional process that is partially shown in FIG. 6. The convolutional process illustrated by boxes 710-760 is performed three times, each time producing a result. Result 770a is produced from a first pass through boxes 710-760, result 770b is produced from a second pass, and final result 780 is from a final pass.

At box 710, the computing system selects an input on which to perform the convolutional process. For the first pass through boxes 710-760, the “unfiltered” range Dopplers 450 and 520 are selected as the input.

At box 720, a convolutional process is performed on the “unfiltered” range Dopplers 450 and 520. This convolutional process may be the first convolutional process 610 that is illustrated in FIG. 6, which produces a set of feature maps 616. Box 720 includes the text “3×3, 12” to indicate that the filters applied to the input data have a size of 3×3, and that 12 feature maps are generated.

After the feature maps are generated, the computing system may perform a batch normalization on the feature maps. A batch normalization can standardize the mean and variance of each feature map, for example, by subtracting the batch mean and then dividing by the standard deviation of the batch. The computing system can also apply an activation function to the feature maps (e.g., a rectified linear unit activation function, which may remove interdependencies and add non-linearities to the data). The feature maps from other convolutional processes discussed below may similarly be batch normalized and activated.

At box 730, the computing system performs a similar convolution, this time using the twelve feature maps produced from the convolution of box 720 as input. This produces twelve intermediate feature maps (in comparison to the two intermediate feature maps illustrated in FIG. 6) that are combined to produce a final feature map. The filters applied at box 730 may be different from those applied at box 720.

Box 740 represents a “shortcut” branch that produces a feature map with a same size as that produced by boxes 720 and 730. The convolution process of box 740 is the same as those of box 720, except that the filter size is 1×1. Employing such a shortcut is sometimes called using a “residual” network.

Box 750 represents a decision point that selects among: (i) the set of twelve feature maps produced by boxes 720 and 730, and (ii) the set of twelve feature maps produced by box 740. The selection may be random, based on criteria that analyzes content of the various feature maps, and/or based on selecting the feature maps of box 740 only when the feature maps of boxes 720 and 730 do not converge.

At box 760, the computing system reduces dimensions of the twelve feature maps selected at box 750. For example, the computing system can perform a MaxPooling operation on the feature maps to cut each dimension in half. The MaxPooling operation selects, from each set of 2×2 pixels forming a feature map, a most significant value. An alternative mechanism to reduce dimensions is to average the values in each 2×2 configuration.

As noted above, a first pass through this convolutional process generates a set 770a of twelve feature maps with 12×46 dimensions (reduced from 24×92 at box 760). These twelve feature maps are used as the input for a second pass through the operations of boxes 710-760, generating a set 770b of twelve feature maps with 6×23 dimensions (reduced from 12×46 at box 760). These twelve feature maps are used as the input for a third and final pass through the operations of boxes 710-760, generating a final set 780 of twelve feature maps with 3×11 dimensions (reduced from 6×23 at box 760).

As indicated by box 702, the operations illustrated in FIG. 7 (and described above), are performed another time using the acoustic data 490 and 540 that has been high-pass filtered (e.g., looping through operations 710-760, using acoustic data 490 and 540 as the initial input). The result of this additional convolutional process is a set 790 of twelve feature maps with 3×11 dimensions.

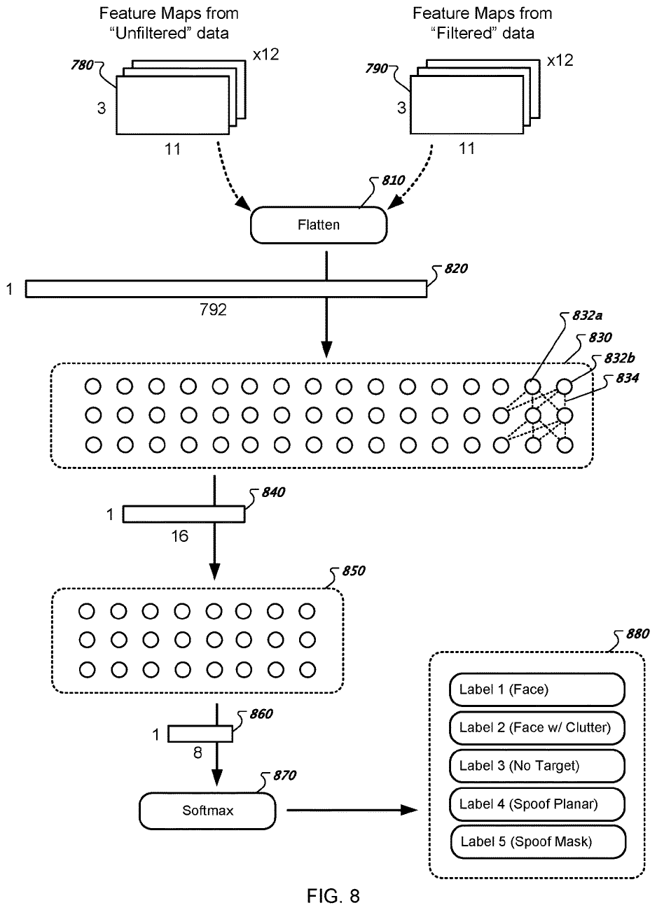

FIG. 8 illustrates how the computing system generates parameters for a computational model. The computational model illustrated in FIG. 8 is a neural network (e.g., a deep neural network) with two sets 830 and 850 of dense layers that are trained based on: (i) content of input feature maps 780 and 790, and (ii) a classification 880 of type of environment in which the acoustic data was initially recorded.

At box 810, the computing system flattens the sets 780 and 790 of feature maps generated by the operations of FIG. 7 into a first one-dimensional array. In this example, twenty four feature maps that are each 3x11 are flattened into a first array 792 digits long.

The first array 820 is connected as an input to a first set 830 of dense layers In the FIG. 8 illustration, each layer of the first set 830 of dense layers has sixteen nodes and the first set 830 of dense layers is connected at its output to a second array 840 that is sixteen digits long.

The second array 830 is connected as an input to a second set 850 of dense layers. In the FIG. 8 illustration, each layer of the second set 850 of dense layers has eight nodes and the second set 850 of dense layers is connected at its output to a third second array 860 that is sixteen digits long.

Each of the sets 830 and 850 of dense layers include weights that define relationships between the nodes and input/output arrays. For example, the first set 830 of dense layers defines a weight between node 832a and each number in the first array 820, such that there are 792 weights between node 832a and the first array 820. This is true for each node in the first layer, such that the first set 830 of dense layers defines an additional 792 weights between node 832b and the first array 820.

The first set 830 of dense layers also defines weights between every node of the first level and every node of the second level, such that there are sixteen weights between node 832a and the second layer. The same is true of weights between the second layer and the third layer, and between the third layer and the second array 840. FIG. 8 illustrates the first set 830 of dense layers as having three layers, but the first set 830 may include a different number of layers (e.g., twelve layers).

The second set 850 of dense layers also defines weights between the nodes and the input/output arrays, with differences from the first set 830 including: (i) each layer is eight nodes wide instead of sixteen nodes wide, (ii) the input array 840 is sixteen digits long instead of 792, and the output array 860 is eight digits long. FIG. 8 illustrates the second set 850 of dense layers as having three layers, but the second set 850 may include a different number of layers (e.g., eight layers).

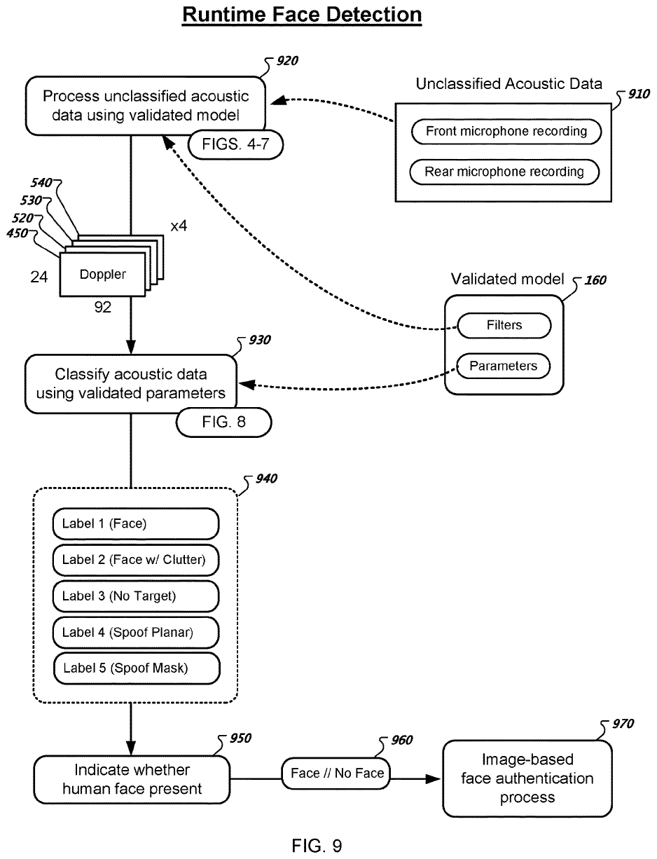

At box 870, a softmax operation or another suitable process converts the eight-digit-long array 860 to a classification 880 of a type of environment in which the acoustic data was initially recorded. The classification 880 is five digits long, including a value between 0 and 1.00 for each of the five labels shown in FIG. 8 (e.g., a human face, a human face with a behind-device object, no object within the analyzed distance of the mobile device, a planar spoof such as a sheet of paper, and a mask spoof such as a mask of a person). In some examples, the values for the labels add up to 1.00. In some examples, the labels shown in FIGS. 8 and 9 include additional labels (e.g., generic spoof with a back-of-device object, spoof planar with a back-of-device object, and spoof mask with a back-of-device object). In some examples, rather than having one or more labels referencing a back-of-device object, one or more labels indicate presence of an object that is located any radial direction from the device (e.g., human face with another object).

During training of the face-detection system, values for the classification 880 is provided along with the acoustic data, to cause a computing system to determine values for the weights in the computational model represented by the sets 830 and 850 of dense layers. As discussed later, during validation and runtime operation of the face detection system, the weights of the neural network are provided (not learned), such that the system determines the classification 880 (rather than the classification being provided by the input data).

The above-described process results in: (i) a selected set of filters applied to the various acoustic data during convolutions, and (ii) a determined set of weights for a computational model. These components together represent a trained model, and the above-described process may be repeated multiple times with different sets of classified training data and/or different filters to generate the set of trained models 320 illustrated in FIG. 3.

The bottom portion of FIG. 3 shows a process for validating a trained model. At box 340, a computing system selects a trained model from the set of trained models 320. The computing system may be the same computing system that trained the models or a different computing system.

At box 342, the computing system processes the acoustic data. The operations of box 342 are similar to those already described with respect to box 312 and FIGS. 4-7, except with different acoustic data and using a set of filters from the selected trained model (rather than an algorithm or human user specifying a set of filters as with box 312).

At box 344, the computing system classifies the acoustic data 344. The operations of box 344 are similar to those already described with respect to box 314 and FIG. 8, except using a set of parameters from the selected trained model and producing a classification (rather than determining a set of parameters using a pre-defined classification as with box 314).

At box 344, the computing system determines a correlation between the classification produced at box 144 and the classification provided by the validation data 330. The operations of boxes 340-144 may be repeated for multiple (e.g., thousands) of acoustic inputs and associated classifications from the set of classification data 330. The determined correlation at box 344 may represent an overall correlation between the classification produced at box 344 and the classifications identified by the set of validation data 330.

These operations for validating a trained model may be repeated for each computation model in the set of trained models 320, such that the operations at box 344 determine a correlation for each of the trained models 320.

At box 350, the computing system selects a trained model that satisfies validation criteria. For example the computing system may select a trained model with a highest correlation, and designate the selected trained model as the validated model 360. The validated model 360 (or a combination of validated models) may be used for a runtime face detection process, such as that described below.

FIG. 9 illustrates a runtime face-detection process. The face-detection process receives unclassified acoustic data 910 as an input, and applies the acoustic data to a validated model 360 in order to produce a classification for the acoustic data.

The unclassified acoustic data 910 may include two audio recordings, for example, one produced by the front-facing microphone 120 and one produced by the rear-facing microphone 160 of the mobile computing device 100 shown in FIGS. 1 and 2.

At box 920, a computing system, for example the mobile computing device 100 or another device in communication therewith, may process the unclassified acoustic data by performing the process described with respect to FIGS. 4-7, but using the filters from the validated computational model 360 (rather than an algorithm or human user specifying a set of filters, as with box 312 in FIG. 3). The operations of box 920 generates acoustic data (e.g., the set of four range Dopplers shown in FIG. 5).

At box 930, the computing system classifies the acoustic data, for example, by performing the operations described with respect to FIG. 9, but using the parameters from the validated computational model 360 (rather than determining a set of parameters using a pre-defined classification, as with box 314). The operations of box 930 generates a classification 940. The classification 940 may include a set of five numbers for the five classification labels illustrated in FIG. 9 (e.g., with each number being between 0 and 1.00, and all the numbers adding up to 1.00).

The computing system may provide the classification 940 to another computational process or application program, or may use such information alone or with other information to perform a face authentication process.

In some implementations, the computing system performs the operations of box 950 to determine from the classification 940 whether a human face is present in front of the mobile computing device 100, and provides an indication 960 of such determination (e.g., outputting a “1” to indicate presence of a face and a “0” to indicate no presence of a face).

At box 970, an image-based face authentication process receives the indication 960 of whether a face is present in front of the mobile computing device 940, and the image-based face authentication process uses the indication 960 in a determination of whether to authenticate access to protected computing resources. For example, the image-based face authentication process may prohibit access to the protected computing resources if the indication 960 is that there is no face, even if the image-based face authentication process otherwise determines that a captured image matches a stored image of an authenticated user (e.g., due to a malicious user holding a printed image of the authenticated user in front of the device). In some examples, the computing device performs an infrared and/or dot projector authentication instead of or in addition to the image-based face authentication process.

Although this disclosure has presented some example ways to train and use a computational model (e.g., using residual Neural Networks with convolutions and shortcuts), the nature of the model and the training performed can be of any appropriate form, and can include one or more of: decision tree learning, random forest, logistic regression, association rule learning, artificial neural networks, deep learning, inductive logic programming, support vector machines, clustering, Bayesian networks, reinforcement learning, representation learning, similarity and metric learning, genetic algorithms, rule-based machine learning, learning classifier systems, or the like.

Although this disclosure has discussed determination of whether a face is present in front of a device, the technology presented in this disclosure may be used to determine whether another type of object is present in front of a device. Indeed, the technology may be expanded to detect dozens or hundreds of objects, either using a single model or a collection of dozens or hundreds of models. Such object detection processes may work with acoustic data by itself, or may work in conjunction processes that use an orthogonal sensor (e.g., an object detection process that analyzes an image captured by an image sensor, and compares the analyzed image to a stored image).

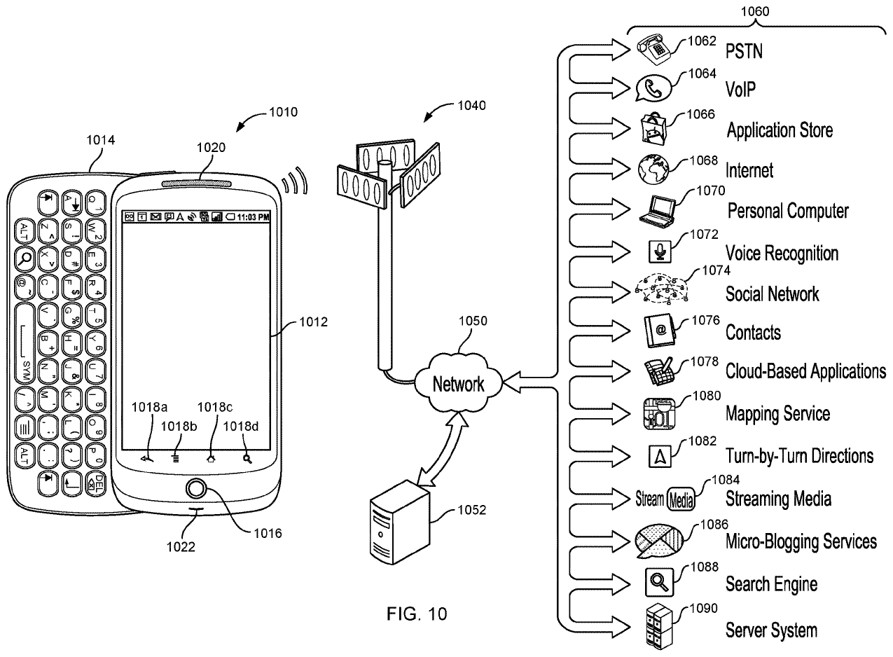

Referring now to FIG. 10, a conceptual diagram of a system that may be used to implement the systems and methods described in this document is illustrated. In the system, mobile computing device 1010 can wirelessly communicate with base station 1040, which can provide the mobile computing device wireless access to numerous hosted services 1060 through a network 1050.

In this illustration, the mobile computing device 1010 is depicted as a handheld mobile telephone (e.g., a smartphone, or an application telephone) that includes a touchscreen display device 1012 for presenting content to a user of the mobile computing device 1010 and receiving touch-based user inputs and/or presence-sensitive user input (e.g., as detected over a surface of the computing device using radar detectors mounted in the mobile computing device 510). Other visual, tactile, and auditory output components may also be provided (e.g., LED lights, a vibrating mechanism for tactile output, or a speaker for providing tonal, voice-generated, or recorded output), as may various different input components (e.g., keyboard 1014, physical buttons, trackballs, accelerometers, gyroscopes, and magnetometers).

Example visual output mechanism in the form of display device 1012 may take the form of a display with resistive or capacitive touch capabilities. The display device may be for displaying video, graphics, images, and text, and for coordinating user touch input locations with the location of displayed information so that the device 1010 can associate user contact at a location of a displayed item with the item. The mobile computing device 1010 may also take alternative forms, including as a laptop computer, a tablet or slate computer, a personal digital assistant, an embedded system (e.g., a car navigation system), a desktop personal computer, or a computerized workstation.

An example mechanism for receiving user-input includes keyboard 1014, which may be a full qwerty keyboard or a traditional keypad that includes keys for the digits ‘0-9’, ‘*’, and ‘#.’ The keyboard 1014 receives input when a user physically contacts or depresses a keyboard key. User manipulation of a trackball 1016 or interaction with a track pad enables the user to supply directional and rate of movement information to the mobile computing device 1010 (e.g., to manipulate a position of a cursor on the display device 1012).

The mobile computing device 1010 may be able to determine a position of physical contact with the touchscreen display device 1012 (e.g., a position of contact by a finger or a stylus). Using the touchscreen 1012, various “virtual” input mechanisms may be produced, where a user interacts with a graphical user interface element depicted on the touchscreen 1012 by contacting the graphical user interface element. An example of a “virtual” input mechanism is a “software keyboard,” where a keyboard is displayed on the touchscreen and a user selects keys by pressing a region of the touchscreen 1012 that corresponds to each key.

The mobile computing device 1010 may include mechanical or touch sensitive buttons 1018a-d. Additionally, the mobile computing device may include buttons for adjusting volume output by the one or more speakers 1020, and a button for turning the mobile computing device on or off. A microphone 1022 allows the mobile computing device 1010 to convert audible sounds into an electrical signal that may be digitally encoded and stored in computer-readable memory, or transmitted to another computing device. The mobile computing device 1010 may also include a digital compass, an accelerometer, proximity sensors, and ambient light sensors.

An operating system may provide an interface between the mobile computing device's hardware (e.g., the input/output mechanisms and a processor executing instructions retrieved from computer-readable medium) and software. Example operating systems include ANDROID, CHROME, IOS, MAC OS X, WINDOWS 7, WINDOWS PHONE 7, SYMBIAN, BLACKBERRY, WEBOS,, a variety of UNIX operating systems; or a proprietary operating system for computerized devices. The operating system may provide a platform for the execution of application programs that facilitate interaction between the computing device and a user.

The mobile computing device 1010 may present a graphical user interface with the touchscreen 1012. A graphical user interface is a collection of one or more graphical interface elements and may be static (e.g., the display appears to remain the same over a period of time), or may be dynamic (e.g., the graphical user interface includes graphical interface elements that animate without user input).

A graphical interface element may be text, lines, shapes, images, or combinations thereof. For example, a graphical interface element may be an icon that is displayed on the desktop and the icon's associated text. In some examples, a graphical interface element is selectable with user-input. For example, a user may select a graphical interface element by pressing a region of the touchscreen that corresponds to a display of the graphical interface element. In some examples, the user may manipulate a trackball to highlight a single graphical interface element as having focus. User-selection of a graphical interface element may invoke a pre-defined action by the mobile computing device. In some examples, selectable graphical interface elements further or alternatively correspond to a button on the keyboard 1014. User-selection of the button may invoke the pre-defined action.

In some examples, the operating system provides a “desktop” graphical user interface that is displayed after turning on the mobile computing device 1010, after activating the mobile computing device 1010 from a sleep state, after “unlocking” the mobile computing device 1010, or after receiving user-selection of the “home” button 1018c. The desktop graphical user interface may display several graphical interface elements that, when selected, invoke corresponding application programs. An invoked application program may present a graphical interface that replaces the desktop graphical user interface until the application program terminates or is hidden from view.

User-input may influence an executing sequence of mobile computing device 1010 operations. For example, a single-action user input (e.g., a single tap of the touchscreen, swipe across the touchscreen, contact with a button, or combination of these occurring at a same time) may invoke an operation that changes a display of the user interface. Without the user-input, the user interface may not have changed at a particular time. For example, a multi-touch user input with the touchscreen 1012 may invoke a mapping application to “zoom-in” on a location, even though the mapping application may have by default zoomed-in after several seconds.

The desktop graphical interface can also display “widgets.” A widget is one or more graphical interface elements that are associated with an application program that is executing, and that display on the desktop content controlled by the executing application program. A widget's application program may launch as the mobile device turns on. Further, a widget may not take focus of the full display. Instead, a widget may only “own” a small portion of the desktop, displaying content and receiving touchscreen user-input within the portion of the desktop.

The mobile computing device 1010 may include one or more location-identification mechanisms. A location-identification mechanism may include a collection of hardware and software that provides the operating system and application programs an estimate of the mobile device's geographical position. A location-identification mechanism may employ satellite-based positioning techniques, base station transmitting antenna identification, multiple base station triangulation, internet access point IP location determinations, inferential identification of a user's position based on search engine queries, and user-supplied identification of location (e.g., by receiving user a “check in” to a location).

The mobile computing device 1010 may include other applications, computing sub-systems, and hardware. A call handling unit may receive an indication of an incoming telephone call and provide a user the capability to answer the incoming telephone call. A media player may allow a user to listen to music or play movies that are stored in local memory of the mobile computing device 1010. The mobile computing device 1010 may include a digital camera sensor, and corresponding image and video capture and editing software. An internet browser may enable the user to view content from a web page by typing in an addresses corresponding to the web page or selecting a link to the web page.

The mobile computing device 1010 may include an antenna to wirelessly communicate information with the base station 1040. The base station 1040 may be one of many base stations in a collection of base stations (e.g., a mobile telephone cellular network) that enables the mobile computing device 1010 to maintain communication with a network 1050 as the mobile computing device is geographically moved. The computing device 1010 may alternatively or additionally communicate with the network 1050 through a Wi-Fi router or a wired connection (e.g., ETHERNET, USB, or FIREWIRE). The computing device 1010 may also wirelessly communicate with other computing devices using BLUETOOTH protocols, or may employ an ad-hoc wireless network.

A service provider that operates the network of base stations may connect the mobile computing device 1010 to the network 1050 to enable communication between the mobile computing device 1010 and other computing systems that provide services 1060. Although the services 1060 may be provided over different networks (e.g., the service provider's internal network, the Public Switched Telephone Network, and the Internet), network 1050 is illustrated as a single network. The service provider may operate a server system 1052 that routes information packets and voice data between the mobile computing device 1010 and computing systems associated with the services 1060.

The network 1050 may connect the mobile computing device 1010 to the Public Switched Telephone Network (PSTN) 1062 in order to establish voice or fax communication between the mobile computing device 1010 and another computing device. For example, the service provider server system 1052 may receive an indication from the PSTN 1062 of an incoming call for the mobile computing device 1010. Conversely, the mobile computing device 1010 may send a communication to the service provider server system 1052 initiating a telephone call using a telephone number that is associated with a device accessible through the PSTN 1062.

The network 1050 may connect the mobile computing device 1010 with a Voice over Internet Protocol (VoIP) service 1064 that routes voice communications over an IP network, as opposed to the PSTN. For example, a user of the mobile computing device 1010 may invoke a VoIP application and initiate a call using the program. The service provider server system 1052 may forward voice data from the call to a VoIP service, which may route the call over the internet to a corresponding computing device, potentially using the PSTN for a final leg of the connection.

An application store 1066 may provide a user of the mobile computing device 1010 the ability to browse a list of remotely stored application programs that the user may download over the network 1050 and install on the mobile computing device 1010. The application store 1066 may serve as a repository of applications developed by third-party application developers. An application program that is installed on the mobile computing device 1010 may be able to communicate over the network 1050 with server systems that are designated for the application program. For example, a VoIP application program may be downloaded from the Application Store 1066, enabling the user to communicate with the VoIP service 1064.

The mobile computing device 1010 may access content on the internet 1068 through network 1050. For example, a user of the mobile computing device 1010 may invoke a web browser application that requests data from remote computing devices that are accessible at designated universal resource locations. In various examples, some of the services 1060 are accessible over the internet.

The mobile computing device may communicate with a personal computer 1070. For example, the personal computer 1070 may be the home computer for a user of the mobile computing device 1010. Thus, the user may be able to stream media from his personal computer 1070. The user may also view the file structure of his personal computer 1070, and transmit selected documents between the computerized devices.

A voice recognition service 1072 may receive voice communication data recorded with the mobile computing device's microphone 1022, and translate the voice communication into corresponding textual data. In some examples, the translated text is provided to a search engine as a web query, and responsive search engine search results are transmitted to the mobile computing device 1010.

The mobile computing device 1010 may communicate with a social network 1074. The social network may include numerous members, some of which have agreed to be related as acquaintances. Application programs on the mobile computing device 1010 may access the social network 1074 to retrieve information based on the acquaintances of the user of the mobile computing device. For example, an “address book” application program may retrieve telephone numbers for the user's acquaintances. In various examples, content may be delivered to the mobile computing device 1010 based on social network distances from the user to other members in a social network graph of members and connecting relationships. For example, advertisement and news article content may be selected for the user based on a level of interaction with such content by members that are “close” to the user (e.g., members that are “friends” or “friends of friends”).

The mobile computing device 1010 may access a personal set of contacts 1076 through network 1050. Each contact may identify an individual and include information about that individual (e.g., a phone number, an email address, and a birthday). Because the set of contacts is hosted remotely to the mobile computing device 1010, the user may access and maintain the contacts 1076 across several devices as a common set of contacts.

The mobile computing device 1010 may access cloud-based application programs 1078. Cloud-computing provides application programs (e.g., a word processor or an email program) that are hosted remotely from the mobile computing device 1010, and may be accessed by the device 1010 using a web browser or a dedicated program. Example cloud-based application programs include GOOGLE DOCS word processor and spreadsheet service, GOOGLE GMAIL webmail service, and PICASA picture manager.

Mapping service 1080 can provide the mobile computing device 1010 with street maps, route planning information, and satellite images. An example mapping service is GOOGLE MAPS. The mapping service 1080 may also receive queries and return location-specific results. For example, the mobile computing device 1010 may send an estimated location of the mobile computing device and a user-entered query for “pizza places” to the mapping service 1080. The mapping service 1080 may return a street map with “markers” superimposed on the map that identify geographical locations of nearby “pizza places.”

Turn-by-turn service 1082 may provide the mobile computing device 1010 with turn-by-turn directions to a user-supplied destination. For example, the turn-by-turn service 1082 may stream to device 1010 a street-level view of an estimated location of the device, along with data for providing audio commands and superimposing arrows that direct a user of the device 1010 to the destination.

Various forms of streaming media 1084 may be requested by the mobile computing device 1010. For example, computing device 1010 may request a stream for a pre-recorded video file, a live television program, or a live radio program. Example services that provide streaming media include YOUTUBE and PANDORA.

A micro-blogging service 1086 may receive from the mobile computing device 1010 a user-input post that does not identify recipients of the post. The micro-blogging service 1086 may disseminate the post to other members of the micro-blogging service 1086 that agreed to subscribe to the user.

A search engine 1088 may receive user-entered textual or verbal queries from the mobile computing device 1010, determine a set of internet-accessible documents that are responsive to the query, and provide to the device 1010 information to display a list of search results for the responsive documents. In examples where a verbal query is received, the voice recognition service 1072 may translate the received audio into a textual query that is sent to the search engine.

These and other services may be implemented in a server system 1090. A server system may be a combination of hardware and software that provides a service or a set of services. For example, a set of physically separate and networked computerized devices may operate together as a logical server system unit to handle the operations necessary to offer a service to hundreds of computing devices. A server system is also referred to herein as a computing system.

In various implementations, operations that are performed “in response to” or “as a consequence of” another operation (e.g., a determination or an identification) are not performed if the prior operation is unsuccessful (e.g., if the determination was not performed). Operations that are performed “automatically” are operations that are performed without user intervention (e.g., intervening user input). Features in this document that are described with conditional language may describe implementations that are optional. In some examples, “transmitting” from a first device to a second device includes the first device placing data into a network for receipt by the second device, but may not include the second device receiving the data. Conversely, “receiving” from a first device may include receiving the data from a network, but may not include the first device transmitting the data.

“Determining” by a computing system can include the computing system requesting that another device perform the determination and supply the results to the computing system. Moreover, “displaying” or “presenting” by a computing system can include the computing system sending data for causing another device to display or present the referenced information.

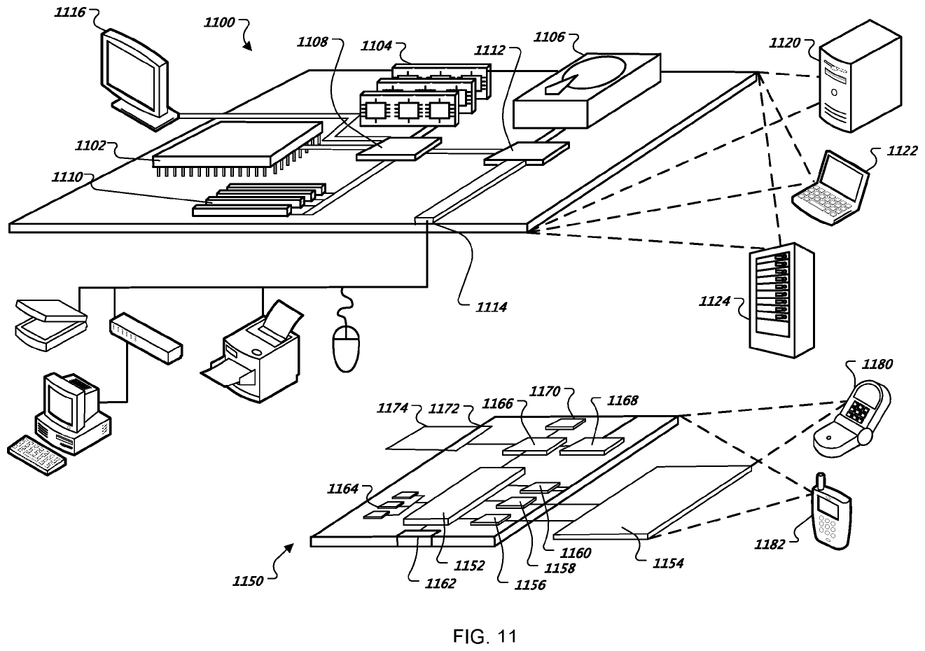

FIG. 11 is a block diagram of computing devices 1100, 1150 that may be used to implement the systems and methods described in this document, as either a client or as a server or plurality of servers. Computing device 1100 is intended to represent various forms of digital computers, such as laptops, desktops, workstations, personal digital assistants, servers, blade servers, mainframes, and other appropriate computers. Computing device 1150 is intended to represent various forms of mobile devices, such as personal digital assistants, cellular telephones, smartphones, and other similar computing devices. The components shown here, their connections and relationships, and their functions, are meant to be examples only, and are not meant to limit implementations described and/or claimed in this document.

Computing device 1100 includes a processor 1102, memory 1104, a storage device 1106, a high-speed controller 1108 connecting to memory 1104 and high-speed expansion ports 1110, and a low speed controller 1112 connecting to low speed expansion port 1114 and storage device 1106. Each of the components 1102, 1104, 1106, 1108, 1110, and 1112, are interconnected using various busses, and may be mounted on a common motherboard or in other manners as appropriate. The processor 1102 can process instructions for execution within the computing device 1100, including instructions stored in the memory 1104 or on the storage device 1106 to display graphical information for a GUI on an external input/output device, such as display 1116 coupled to high-speed controller 1108. In other implementations, multiple processors and/or multiple buses may be used, as appropriate, along with multiple memories and types of memory. Also, multiple computing devices 1100 may be connected, with each device providing portions of the necessary operations (e.g., as a server bank, a group of blade servers, or a multi-processor system).

The memory 1104 stores information within the computing device 1100. In one implementation, the memory 1104 is a volatile memory unit or units. In another implementation, the memory 1104 is a non-volatile memory unit or units. The memory 1104 may also be another form of computer-readable medium, such as a magnetic or optical disk.

The storage device 1106 is capable of providing mass storage for the computing device 1100. In one implementation, the storage device 1106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer-or machine-readable medium, such as the memory 1104, the storage device 1106, or memory on processor 1102.

The high-speed controller 1108 manages bandwidth-intensive operations for the computing device 1100, while the low speed controller 1112 manages lower bandwidth-intensive operations. Such allocation of functions is an example only. In one implementation, the high-speed controller 1108 is coupled to memory 1104, display 1116 (e.g., through a graphics processor or accelerator), and to high-speed expansion ports 1110, which may accept various expansion cards (not shown). In the implementation, low-speed controller 1112 is coupled to storage device 1106 and low-speed expansion port 1114. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1100 may be implemented in a number of different forms, as shown in the figure. For example, it may be implemented as a standard server 1120, or multiple times in a group of such servers. It may also be implemented as part of a rack server system 1124. In addition, it may be implemented in a personal computer such as a laptop computer 1122. Alternatively, components from computing device 1100 may be combined with other components in a mobile device (not shown), such as device 1150. Each of such devices may contain one or more of computing device 1100, 1150, and an entire system may be made up of multiple computing devices 1100, 1150 communicating with each other.

Computing device 1150 includes a processor 1152, memory 1164, an input/output device such as a display 1154, a communication interface 1166, and a transceiver 1168, among other components. The device 1150 may also be provided with a storage device, such as a microdrive or other device, to provide additional storage. Each of the components 1150, 1152, 1164, 1154, 1166, and 1168, are interconnected using various buses, and several of the components may be mounted on a common motherboard or in other manners as appropriate.

The processor 1152 can execute instructions within the computing device 1150, including instructions stored in the memory 1164. The processor may be implemented as a chipset of chips that include separate and multiple analog and digital processors. Additionally, the processor may be implemented using any of a number of architectures. For example, the processor may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 1150, such as control of user interfaces, applications run by device 1150, and wireless communication by device 1150.

Processor 1152 may communicate with a user through control interface 1158 and display interface 1156 coupled to a display 1154. The display 1154 may be, for example, a TFT (Thin-Film-Transistor Liquid Crystal Display) display or an OLED (Organic Light Emitting Diode) display, or other appropriate display technology. The display interface 1156 may comprise appropriate circuitry for driving the display 1154 to present graphical and other information to a user. The control interface 1158 may receive commands from a user and convert them for submission to the processor 1152. In addition, an external interface 1162 may be provide in communication with processor 1152, so as to enable near area communication of device 1150 with other devices. External interface 1162 may provided, for example, for wired communication in some implementations, or for wireless communication in other implementations, and multiple interfaces may also be used.

The memory 1164 stores information within the computing device 1150. The memory 1164 can be implemented as one or more of a computer-readable medium or media, a volatile memory unit or units, or a non-volatile memory unit or units. Expansion memory 1174 may also be provided and connected to device 1150 through expansion interface 1172, which may include, for example, a SIMM (Single In Line Memory Module) card interface. Such expansion memory 1174 may provide extra storage space for device 1150, or may also store applications or other information for device 1150. Specifically, expansion memory 1174 may include instructions to carry out or supplement the processes described above, and may include secure information also. Thus, for example, expansion memory 1174 may be provide as a security module for device 1150, and may be programmed with instructions that permit secure use of device 1150. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer-or machine-readable medium, such as the memory 1164, expansion memory 1174, or memory on processor 1152 that may be received, for example, over transceiver 1168 or external interface 1162.

Device 1150 may communicate wirelessly through communication interface 1166, which may include digital signal processing circuitry where necessary. Communication interface 1166 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1168. In addition, short-range communication may occur, such as using a Bluetooth, WiFi, or other such transceiver (not shown). In addition, GPS (Global Positioning System) receiver module 1170 may provide additional navigation-and location-related wireless data to device 1150, which may be used as appropriate by applications running on device 1150.

Device 1150 may also communicate audibly using audio codec 1160, which may receive spoken information from a user and convert it to usable digital information. Audio codec 1160 may likewise generate audible sound for a user, such as through a speaker, e.g., in a handset of device 1150. Such sound may include sound from voice telephone calls, may include recorded sound (e.g., voice messages, music files, etc.) and may also include sound generated by applications operating on device 1150.

The computing device 1150 may be implemented in a number of different forms, as shown in the figure. For example, it may be implemented as a cellular telephone 1180. It may also be implemented as part of a smartphone 1182, personal digital assistant, or other similar mobile device.

Additionally computing device 1100 or 1150 can include Universal Serial Bus (USB) flash drives. The USB flash drives may store operating systems and other applications. The USB flash drives can include input/output components, such as a wireless transmitter or USB connector that may be inserted into a USB port of another computing device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

As additional description to the embodiments described above, this disclosure describes the following embodiments.

Embodiment 1 is a computer-implemented method, comprising: outputting, by a speaker of a computing device, an acoustic waveform; recording, by a first microphone of the computing device, a first reflection of the acoustic waveform that was output by the speaker; recording, by a second microphone of the computing device, a second reflection of the acoustic waveform that was output by the speaker; determining, by the computing device, a computed representation of an environment surrounding the computing device, based on the first reflection of the acoustic waveform and the second reflection of the acoustic waveform; providing, by the computing device, the computed representation of the environment surrounding the computing device to a computational model that is configured to determine whether the computed representation of the environment surrounding the computing device indicates presence of a human face; and receiving, from the computational model, an indication that the environment surrounding the computing device includes a human face.

Embodiment 2 is the computer-implemented method of embodiment 1, wherein: the computing device has a front side and a rear side that is opposite the first side; the front side provides a display device, the speaker, and the first microphone; and the rear side provides the second microphone.

Embodiment 3 is the computer-implemented method of embodiment 2, wherein: the front side provides a front-facing image sensor; and the method comprises providing an indication that the environment surrounding the computing device includes a human face to a face verification system that is configured to compare: (i) an image captured by the front-facing image sensor; and (ii) a stored representation of a particular human face configured to authenticate a user account.

Embodiment 4 is the computer-implemented method of any one of embodiments 2-3, wherein: the front side includes a first planar surface; the rear side includes a second planar surface that is parallel to the first planar surface; the speaker is located within a first aperture that is defined by the first planar surface; and the first microphone is located within the first aperture defined by the first planar surface or a second aperture defined by the second planar surface.

Embodiment 5 is the computer-implemented method of embodiment 4, wherein the speaker and the first microphone are covered by a common mesh grill.

Embodiment 6 is the computer-implemented method of any one of embodiments 4-5, wherein: the front side of the computing device is separated from the rear side of the computing device by a periphery of the computing device that includes a top side, a bottom side that opposes the top side, a left side, and a right side that opposes the left side; the first speaker and the first microphone are located on the front side of the computing device, closer to the top side of the periphery of the computing device than a center of the computing device; and the second microphone is located on the rear side of the computing device, closer to the top side of the periphery of the computing device than the center of the computing device.

Embodiment 7 is the computer-implemented method of any one of embodiments 1-6, wherein the acoustic waveform includes a series of ultrasonic pulses.

Embodiment 8 is the computer-implemented method of any one of embodiments 1-7, wherein determining the computed representation of the environment surrounding the computing device includes: generating a first range Doppler representation based on the first reflection of the acoustic waveform; and generating a second range Doppler representation based on the second reflection of the acoustic waveform.

Embodiment 9 is the computer-implemented method of embodiment 8, wherein determining the computed representation of the environment surrounding the computing device includes: performing a convolutional process that includes combining a feature map generated from a convolution of the first range Doppler representation and a feature map generated from a convolution of the second range Doppler representation.

Embodiment 10 is the computer-implemented method of any one of embodiments 8-9, wherein determining the computed representation of the environment surrounding the computing device includes: applying a high-pass filter to the first reflection of the acoustic waveform to generate a high-pass-filtered version of the first reflection of the acoustic waveform; generating a third range Doppler representation based on the high-pass-filtered version of the first reflection of the acoustic waveform; and applying a high-pass filter to the second reflection of the acoustic waveform to generate a high-pass-filtered version of the second reflection of the acoustic waveform; and generating a fourth range Doppler representation based on the high-pass-filtered version of the first reflection of the acoustic waveform.

Embodiment 11 is the computer-implemented method of embodiment 10, wherein: applying a high-pass filter to the first reflection of the acoustic waveform includes applying a high-pass filter to a first range profile that represents a first series of reflections of ultrasonic pulses contained within the first reflection of the acoustic waveform; and applying a high-pass filter to the second reflection of the acoustic waveform includes applying a high-pass filter to a second range profile that represents a second series of reflections of ultrasonic pulses contained within the second reflection of the acoustic waveform.

Embodiment 12 is the computer-implemented method of any one of embodiments 10-11, wherein determining the computed representation of the environment surrounding the computing device includes: calculating the computed representation of the environment surrounding the computing device based on: (i) a first convolution of the first range Doppler representation and the second range Doppler representation to generate a first convolutional output; (ii) a second convolution of the third range Doppler representation to generate a second convolutional output; and (iii) a third convolution of the fourth range Doppler representation to generate a third convolutional output.

Embodiment 13 is the computer-implemented method of embodiment 12, wherein: the first convolutional output comprises a two-dimensional array of values; the second convolutional output comprises a two-dimensional array of values; the third convolutional output comprises a two-dimensional array of values; flattening the first convolutional output, the second convolutional output, and the third convolutional output into a one-dimensional array; and the computed representation of the environment surrounding the computing device that is provided to the computational model comprises the one-dimensional array.

Embodiment 14 is the computer-implemented method of any one of embodiments 1-13, wherein: the computational model includes a neural network with multiple dense layers including weights, with the neural network having been trained on: (i) a first set of reflections of acoustic waveforms recorded by a device with a human face located in front of the device; and (ii) a second set of reflections of acoustic waveforms recorded by a device with a mask of a human face located in front of the device.

Embodiment 15 is the computer-implemented method of embodiment 14, wherein: the neural network was trained on: (iii) a third set of reflections of acoustic waveforms recorded by a device with a flat surface located in front of the device; and (iv) a fourth set of reflections of acoustic waveforms recorded by a device with a human face located in front of the device and with an object located in back of the device, opposite the human face.

Embodiment 16 is the computer-implemented method of any one of embodiments 1-15, wherein: outputting, by the speaker of the computing device, a second acoustic waveform; determining, by the computing device, a second computed representation of an environment surrounding the computing device, based on a first reflection of the second acoustic waveform recorded by the first microphone and a second reflection of the second acoustic waveform recorded by the second microphone; providing, by the computing device, the second computed representation of the environment surrounding the computing device to the computational model; and receiving, from the computational model, an indication that the environment surrounding the computing device includes both: (i) a human face; and (ii) an object on an opposite side of the computing device from the human face.

Embodiment 17 is a computing device, comprising: a display device that is provided by a front side of the computing device; a speaker that is provided by the front side of the computing device; a first microphone that is provided by the front side of the computing device; a second microphone that is provided by a rear side of the computing device that is opposite the front side of the computing device; one or more processors; and one or more computer-readable devices including instructions that, when executed by the one or more processors, cause the computing device to perform operations that comprise: outputting, by the speaker, an acoustic waveform; recording, by the first microphone, a first reflection of the acoustic waveform that was output by the speaker; recording, by the second microphone, a second reflection of the acoustic waveform that was output by the speaker; determining a computed representation of an environment surrounding the computing device, based on the first reflection of the acoustic waveform and the second reflection of the acoustic waveform; providing the computed representation of the environment surrounding the computing device to a computational model that is configured to determine whether the computed representation of the environment surrounding the computing device indicates presence of a human face; and receiving, from the computational model, an indication that the environment surrounding the computing device includes a human face.

Embodiment 18 is the computing device of embodiment 17, further configured to perform the method of any one of embodiments 2-16.

Although a few implementations have been described in detail above, other modifications are possible. Moreover, other mechanisms for performing the systems and methods described in this document may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A computer-implemented method, comprising:
outputting, by a speaker of a computing device, an acoustic waveform;
recording, by a first microphone of the computing device, a first reflection of the acoustic waveform that was output by the speaker;
recording, by a second microphone of the computing device, a second reflection of the acoustic waveform that was output by the speaker;
determining, by the computing device, a computed representation of an environment surrounding the computing device, based on the first reflection of the acoustic waveform and the second reflection of the acoustic waveform;
providing, by the computing device, the computed representation of the environment surrounding the computing device to a computational model that is configured to determine whether the computed representation of the environment surrounding the computing device indicates presence of a human face; and
receiving, from the computational model, an indication that the environment surrounding the computing device includes a human face.

2. The computer-implemented method of claim 1, wherein:
the computing device has a front side and a rear side that is opposite the first side;
the front side provides a display device, the speaker, and the first microphone; and
the rear side provides the second microphone.

3. The computer-implemented method of claim 2, wherein:
the front side provides a front-facing image sensor; and
the method comprises providing an indication that the environment surrounding the computing device includes a human face to a face verification system that is configured to compare:
(i) an image captured by the front-facing image sensor; and
(ii) a stored representation of a particular human face configured to authenticate a user account.

4. The computer-implemented method of claim 2, wherein:
the front side includes a first planar surface;
the rear side includes a second planar surface that is parallel to the first planar surface;
the speaker is located within a first aperture that is defined by the first planar surface; and
the first microphone is located within the first aperture defined by the first planar surface or a second aperture defined by the second planar surface.

5. The computer-implemented method of claim 4, wherein the speaker and the first microphone are covered by a common mesh grill.

6. The computer-implemented method of claim 4, wherein:
the front side of the computing device is separated from the rear side of the computing device by a periphery of the computing device that includes a top side, a bottom side that opposes the top side, a left side, and a right side that opposes the left side;
the first speaker and the first microphone are located on the front side of the computing device, closer to the top side of the periphery of the computing device than a center of the computing device; and
the second microphone is located on the rear side of the computing device, closer to the top side of the periphery of the computing device than the center of the computing device.

7. The computer-implemented method of claim 1, wherein the acoustic waveform includes a series of ultrasonic pulses.

8. The computer-implemented method of claim 1, wherein determining the computed representation of the environment surrounding the computing device includes:
generating a first range Doppler representation based on the first reflection of the acoustic waveform; and
generating a second range Doppler representation based on the second reflection of the acoustic waveform.

9. The computer-implemented method of claim 8, wherein determining the computed representation of the environment surrounding the computing device includes:
performing a convolutional process that includes combining a feature map generated from a convolution of the first range Doppler representation and a feature map generated from a convolution of the second range Doppler representation.

10. The computer-implemented method of claim 8, wherein determining the computed representation of the environment surrounding the computing device includes:
applying a high-pass filter to the first reflection of the acoustic waveform to generate a high-pass-filtered version of the first reflection of the acoustic waveform;
generating a third range Doppler representation based on the high-pass-filtered version of the first reflection of the acoustic waveform; and
applying a high-pass filter to the second reflection of the acoustic waveform to generate a high-pass-filtered version of the second reflection of the acoustic waveform; and
generating a fourth range Doppler representation based on the high-pass-filtered version of the first reflection of the acoustic waveform.

11. The computer-implemented method of claim 10, wherein:
applying a high-pass filter to the first reflection of the acoustic waveform includes applying a high-pass filter to a first range profile that represents a first series of reflections of ultrasonic pulses contained within the first reflection of the acoustic waveform; and
applying a high-pass filter to the second reflection of the acoustic waveform includes applying a high-pass filter to a second range profile that represents a second series of reflections of ultrasonic pulses contained within the second reflection of the acoustic waveform.

12. The computer-implemented method of claim 10, wherein determining the computed representation of the environment surrounding the computing device includes:
calculating the computed representation of the environment surrounding the computing device based on:
(i) a first convolution of the first range Doppler representation and the second range Doppler representation to generate a first convolutional output;
(ii) a second convolution of the third range Doppler representation to generate a second convolutional output; and
(iii) a third convolution of the fourth range Doppler representation to generate a third convolutional output.

13. The computer-implemented method of claim 12, wherein:
the first convolutional output comprises a two-dimensional array of values;
the second convolutional output comprises a two-dimensional array of values;
the third convolutional output comprises a two-dimensional array of values;
flattening the first convolutional output, the second convolutional output, and the third convolutional output into a one-dimensional array; and
the computed representation of the environment surrounding the computing device that is provided to the computational model comprises the one-dimensional array.

14. The computer-implemented method of claim 1, wherein:
the computational model includes a neural network with multiple dense layers including weights, with the neural network having been trained on:
(i) a first set of reflections of acoustic waveforms recorded by a device with a human face located in front of the device; and
(ii) a second set of reflections of acoustic waveforms recorded by a device with a mask of a human face located in front of the device.

15. The computer-implemented method of claim 14, wherein:
the neural network was trained on:
(iii) a third set of reflections of acoustic waveforms recorded by a device with a flat surface located in front of the device; and
(iv) a fourth set of reflections of acoustic waveforms recorded by a device with a human face located in front of the device and with an object located in back of the device, opposite the human face.

16. The computer-implemented method of claim 1, wherein:
outputting, by the speaker of the computing device, a second acoustic waveform;
determining, by the computing device, a second computed representation of an environment surrounding the computing device, based on a first reflection of the second acoustic waveform recorded by the first microphone and a second reflection of the second acoustic waveform recorded by the second microphone;
providing, by the computing device, the second computed representation of the environment surrounding the computing device to the computational model; and
receiving, from the computational model, an indication that the environment surrounding the computing device includes both:
(i) a human face; and
(ii) an object on an opposite side of the computing device from the human face.

17. A computing device, comprising:
a display device that is provided by a front side of the computing device;
a speaker that is provided by the front side of the computing device;
a first microphone that is provided by the front side of the computing device;
a second microphone that is provided by a rear side of the computing device that is opposite the front side of the computing device;
one or more processors; and
one or more computer-readable devices including instructions that, when executed by the one or more processors, cause the computing device to perform operations that comprise:
outputting, by the speaker, an acoustic waveform;
recording, by the first microphone, a first reflection of the acoustic waveform that was output by the speaker;
recording, by the second microphone, a second reflection of the acoustic waveform that was output by the speaker;
determining a computed representation of an environment surrounding the computing device, based on the first reflection of the acoustic waveform and the second reflection of the acoustic waveform;
providing the computed representation of the environment surrounding the computing device to a computational model that is configured to determine whether the computed representation of the environment surrounding the computing device indicates presence of a human face; and
receiving, from the computational model, an indication that the environment surrounding the computing device includes a human face.
